(19) United States
(12) Patent Application Publication
(10) Pub. No.: US 2018/0290522 A1
(43) Pub. Date: Oct. 11, 2018

(54) TRANSISTION AUTOMOBILE WINDOWS

(71) Applicant: Gerardo Rosales, Lancaster, CA (US)

(72) Inventor: Gerardo Rosales, Lancaster, CA (US)

(21) Appl. No.: 15/480,619

(22) Filed: Apr. 6, 2017

(51) Int. Cl. B60J 3/04; B60J 1/02; B60J 1/08; B60J 1/18; G02B 5/23

(52) U.S. Cl. CPC B60J 3/04; B60J 1/02; G02B 5/23; B60J 1/18; B60J 1/08

(57) ABSTRACT

A system and method of vehicle window tinting comprising the steps of: implementing photochromic technology into at least one window of a vehicle; integrating a first degree of shading associated with the at least one window, where the first degree of shading is active when the window lacks sun exposure; adjusting the photochromic technology to create a second degree of shading on the at least one window upon exposure to sun poisoning UV rays, where the second degree of exposure is darker than the first degree of shading. In one particular embodiment, the step of implementing photochromic technology includes implementing the photochromic technology within a front windshield of the vehicle, a rear windshield of the vehicle and/or side windshields of the vehicle.

### BACKGROUND OF THE INVENTION

### Field of Invention

The present invention relates to transitional shading automobile based upon sun and UV exposure.

### Description of Related Art

Many automobile windows provide various levels of tinting and shading to protect the occupants from UV rays that may penetrate the windows. Various forms of UV protection are provided in many automobile windows by the manufacturer. Further users typically may add various levels of shading and tinting to their windows to provide a more obstructive UV radiation protection. Such shading and tinting placed on the windows may help to keep the automobile's interior at a cooler temperature. Many automobile owners in warmer climates that have high exposure to sun radiation implement tinting and shading of the windows not only for eye protection but also to maintain a cool temperature in the vehicle.

Most of the known window shading and tinting of automobile windows provide various degrees of shading. These degrees of shading are usually installed and implemented in a permanent fashion. Consequently, a user may not vary the shading without either replacing the windows or removing a film that is sometimes used to shade windows. Also window tinting and shading may create a problem in some instances during night driving. Further certain states have regulations as to the degree of shading that is permissible on the automobile windows. Many times law enforcement officials require that window shading be in accordance with laws that may be associated and implemented by a particular state. This particular regulation helps to ensure that law enforcements are able to visually see the driver of a vehicle during operation of the vehicle. Consequently it would be advantageous to have photochromic windows installed in an automobile. Photochromic technology reacts to UV and sunlight exposure and then darkens the lens or window based upon the degree of sun exposure.

### SUMMARY OF THE INVENTION

The present invention relates to a system and method of vehicle window tinting comprising the steps of: implementing photochromic technology into at least one window of a vehicle; integrating a first degree of shading associated with the at least one window, where the first degree of shading is active when the window lacks sun exposure; adjusting the photochromic technology to create a second degree of shading on the at least one window upon exposure to sun UV rays, where the second degree of exposure is darker than the first degree of shading. In one particular embodiment, the step of implementing photochromic technology includes implementing the photochromic technology within a front windshield of the vehicle, a rear windshield of the vehicle and/or side windshields of the vehicle.

### BRIEF DESCRIPTION OF DRAWINGS

FIG. 1 depicts a photochromic automobile window system according to the present invention in a clear state, during night time.

FIG. 2 depicts a photochromic window according to the present invention in a shaded state, during day time.

### DETAILED DESCRIPTION

The present invention relates to a method of window tinting for an automobile, specifically implementation of photochromic technology into automobile windows. Photochromic technology is used frequently in eye-glass lenses. This photochromic technology detects the exposure to sun or UV rays and darkens the lenses in accordance with the sun exposure. The present invention implements the photochromic technology into automobile windows wherein that the windows upon exposure to the sun and UV rays darken based on the degree of exposure.

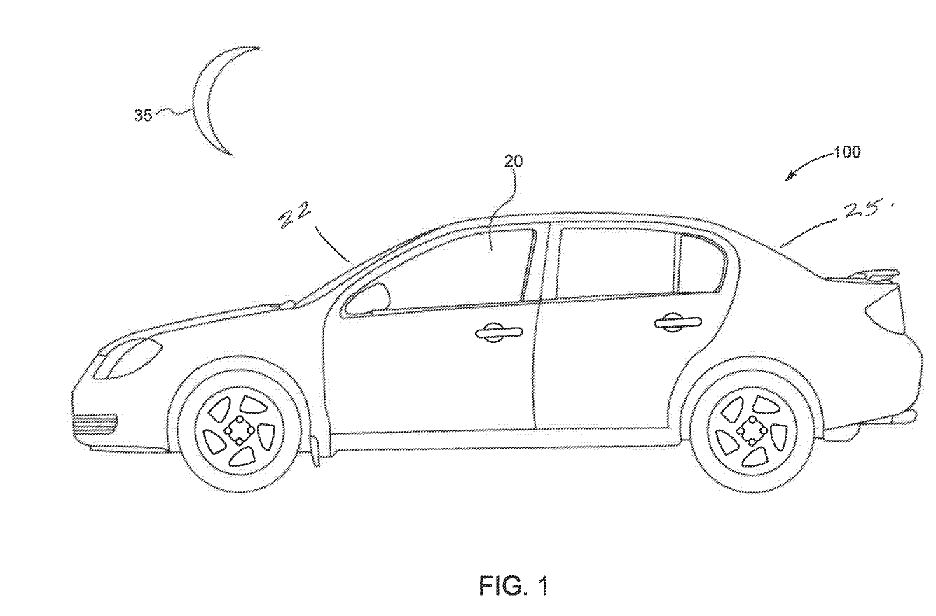

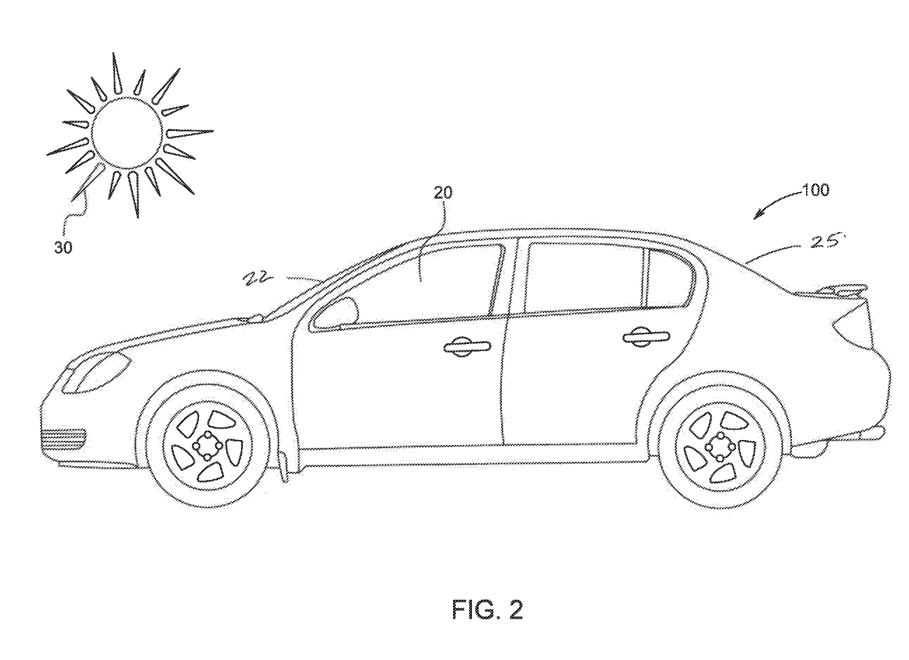

FIG. 1 depicts a vehicle 100 with windows 20 that includes photochromic technology in accordance with the present invention. The windows 20 depicted in FIG. 1 has a first degree of shading that is essentially clear due to lack of sun exposure as depicted in FIG. 1. This degree of shading may vary based upon the exposure to the sun or UV rays emitted by the sun. The photochromic technology within the windows 20 allows for the gradual shading of the windows 20 based upon the sun exposure. In reference to FIG. 2, the windows 20 are depicted in a second degree of shading that would be associated with sun exposure. The use of the photochromic technology on the auto windows according to the present invention provides a shaded window when necessary and may vary in degree of shading in accordance with the sun UV exposure. This window may be implemented in any size or version that is typically associated with the automobile or other type of vehicle such as a truck, motorcycle or aircraft. Further the degree of shading may be varied and limited in accordance with any state regulations associated with automobile window tinting.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. A method of vehicle window tinting comprising the steps of:
a. implementing photochromic technology into each window of a vehicle;
b. integrating a first degree of shading associated with the at least one window, where the first degree of shading is active when the window lacks sun exposure; and
c. adjusting the photochromic technology to create a second degree of shading on window upon exposure to sun poisoning UV rays, where the second degree of exposure is darker than the first degree of shading.

2. The method of vehicle window tinting according to claim 1, where the step of implementing photochromic technology includes implementing the photochromic technology within a front windshield of the vehicle.

3. The method of window tinting according to claim 1, where the step of implementing photochromic technology includes implementing the photochromic technology within a rear windshield of the vehicle.

4. The method of window tinting according to claim 1, where the step of implementing photochromic technology includes implementing the photochromic technology within side windshields of the vehicle.
